(19) United States
(12) Patent Application Publication
(10) Pub. No.: US 2017/0272550 A1
(43) Pub. Date: Sep. 21, 2017

(54) SYSTEMS AND METHODS FOR ESTABLISHING COMMUNICATION INTERFACES TO MONITOR ONLINE INTERACTIONS VIA EVENT LISTENERS

(71) Applicant: Kitedesk, Inc., Tampa, FL (US)

(72) Inventor: Jared Rodriguez, Tampa, FL (US)

(21) Appl. No.: 15/456,149

(22) Filed: Mar. 10, 2017

Related U.S. Application Data
(60) Provisional application No. 62/311,123, filed on Mar. 21, 2016.

(51) Int. Cl. H04L 29/06; H04L 12/24; H04L 12/58

(52) U.S. Cl. CPC H04L 67/42; H04L 51/046; H04L 41/046

(57) ABSTRACT

To increase the efficiency of the sales cycle and reduce costs, manual interactions of the sales cycle can be optimized and prioritized. Various interactions that may be included in the sales process can be scored and prioritized based on their likelihood of gaining a response from a prospect. Additionally, analysis of the success and failure of different interactions can be used to suggest mechanisms of outreach that might not be included within the current sales process, but which are likely to gain a direct response from the prospect.

### RELATED APPLICATIONS

This application claims priority to U.S. Provisional Patent Application No. 62/311,123, entitled “SYSTEMS AND METHODS FOR ESTABLISHING COMMUNICATION INTERFACES TO MONITOR ONLINE INTERACTIONS VIA EVENT LISTENERS” and filed on Mar. 21, 2016, which is hereby incorporated by reference in its entirety.

### FIELD OF DISCLOSURE

The present disclosure is generally directed to various systems and methods for using machine learning techniques to move a sales prospect through the sales process.

### BACKGROUND

Businesses often spend a substantial amount of time and money to find prospects to whom they wish to sell and to move those prospects through the sales process to convert them to paying customers. There are many existing systems, such as marketing automation and lead management systems, to help move such prospects through the sales process in an automated way. Call centers and marketing automation systems can be used to identify and interact with a prospect. But such systems are often ineffective due to the impersonal nature of the communication and their inability to suggest and prioritize manual interactions with prospects in a manner that allows for increased likelihood of converting a prospect to a paying customer.

### BRIEF SUMMARY

Aspects and implementations of the present disclosure are generally directed to systems and methods for establishing communication interfaces to monitor online interactions via event listeners. The solutions provided in the disclosure address the technical problems and challenges of efficiently sending, receiving, and processing electronic communications between business entities for/of a computer-based technology and platform, in the context of a computing environment which includes a network, a plurality of clients or prospects, a plurality of agents, a plurality of electronic communication even listeners configured to detect actions performed by the clients or prospects, and an interaction prioritization engine intermediary to the agents and the clients or prospects. Existing computer-based technologies and platforms do not effectively and efficiently make use of available computing and network resources deployed for such computer-based technologies and platforms to include such functionality. Without implementing such functionality, existing computer-based technologies and platforms suffer from a range of problems, as described further below.

Communications relating to business activities are often carried out in electronic format, for example according to any of a variety of communication protocols such as email and voice over Internet protocol (VOIP). Entities including buyers and sellers routinely communicate with one another electronically across large computer networks, such as the Internet. Due to the relative ease with which electronic communications can be carried out between parties in such a computer network, the number of business entities that choose to communicate electronically is large and growing, and many such entities transmit and receive large numbers of individual electronic communications over the course of a typical business day. As a result, business entities must manage a large volume of electronic communications, which can be costly and time consuming. Specifically, the time required for reading and replying to electronic communications can occupy a substantial portion of the day for human personnel affiliated with business entities. In addition, business entities must maintain complex computer networking infrastructure, and manage (e.g., process, transmit, and store) large amounts of electronic data.

This disclosure describes novel and non-obvious systems and methods for improving the efficiency of the electronic communications often used by business entities. The systems and methods of the present solution are directed to the improvement of the performance and operation of the computer-based technology and platform, and computing and networking resource used by such a computer-based technology and platform. In some aspects, the present solution improves and enhances the implemented functionality of the computer-based technology and platform implemented on, integrated with and inherently tied to a processor, memory, a network and various computing resources of one or more computing devices. In some aspects, the present solution more effectively performs the functionality of the computer-based technology and platform thereby making and causing more effective use of the computing and networking resources to achieve the improved functionality of the present solution. The same computing and network resources used by such computer-based technology and platform will provide increased and improved functionality with implementation of the present solution. In some aspects, the present solution more efficiently uses the computing and networking resources to implement the improved functionality of the computer-based technology and platform. For example, information identifying a prospect or client can be stored in a database. The systems described in this disclosure can extract additional electronic information relating to the clients or prospects in an automated manner, for example by scraping social media profiles or by automatically identifying and parsing emails, electronic calendar items, electronic voice calls, text messages or other forms of electronic communication exchanged with the clients or prospects in order to enhance the known information about the clients or prospects. Based on the enhanced information, the systems described in this disclosure can evaluate electronic communication events that occurred in the past and can predict the likely outcome of future electronic communication events. Thus, the systems described in this disclosure can generate electronic communication events and can store in the electronic communication events in a data structure, such as a queue, that prioritizes electronic communication events which are more likely to have a favorable outcome.

In one aspect, the disclosure relates to techniques for prioritizing the electronic communications in order to reduce a total amount of such communications transmitted and received during the normal course of business for an entity. In one example, a business entity may wish to do business with any of a plurality of potential clients. The business entity can use a computing system which, as described further below, may deploy one or more electronic communication event listeners. The electronic communication event listeners can collect information relating to the electronic communications sent by the business entity, and the information obtained by the electronic communication event listeners can be used to prioritize certain potential electronic communications over others. For example, the computing system may identify one of the plurality of clients and may generate a client ranking score for the client. In some implementations, the client ranking score may relate to actions performed at the client in association with an electronic communication event between the business entity and the client. The electronic communication event may be an email transmission, and the action performed at the client may be, for example, reading the email or selecting a hyperlink included within the email. In another example, the electronic communication even may be a voice call, and the action performed at the client may be receiving the call or returning the call at a later time. In some implementations, the information obtained by the electronic communication event listeners can be used to modify or adjust the client ranking score of the client relative to the client ranking score of other clients. The business entity may then determine an order in which to initiate electronic communications with the clients based on the relative ranking scores of the clients. Prioritizing the electronic communications in this way can lead to a decrease in the total amount of electronic communications transmitted by the business entity, because those electronic communications that are most likely to be effective can be prioritized ahead of those that are less likely to be effective.

Sales agents are often better-suited than automated marketing systems (e.g., call centers) for interacting with prospects in a way that leads to conversion, because sales agents can communicate with a prospect more personally. For example, sales agents can interact with a prospect across a range of channels that can include social media, text, email, and telephone calls. The effectiveness of these mechanisms of outreach by a sales agent can be contingent upon researching the prospect and following a predefined process of interaction. For instance, many organizations use processes that define a mix of outreach such as calling the prospect on day one, social media outreach on day two, emailing the prospect on day three, and calling again on day four. These processes can vary substantially from organization to organization, but typically are most effective when they include personal outreach by a sales agent. There are often multiple processes into which prospects can be placed, with the process selected being targeted to demographic and firmographic details of the prospect.

The outcome of one step of the sales process for outreach can directly impact sequential steps in the process. For instance, a phone call on day one might indicate that the prospect is unavailable for the next three days. This could indicate to a sales agent that the agent should focus on other prospects in the meantime. In another example, a prospect may respond to an email, indicating that a phone call that same day would be the best choice of interaction for a sales agent to take to progress the cycle with respect to that prospect.

While sales agent outreach is often more effective, it also can be much more costly. The cost to employ sales agents and the amount of time it takes for each sales agent to research each prospect can be substantial. As each sales agent is often dealing with a large volume of prospects, understanding which activity to perform next based on previous interactions is often lost. This can result in wasted time and delays in advancement of the sales cycle.

To increase the efficiency of the sales cycle and reduce costs, manual interactions of the sales cycle can be optimized and prioritized. Various interactions that may be included in the sales process can be scored and prioritized based on their likelihood of gaining a response from a prospect. Additionally, analysis of the success and failure of different interactions can be used to suggest mechanisms of outreach that might not be included within the current sales process, but which are likely to gain a direct response from the prospect.

In some implementations, a numerical score may be assigned to the prospect to indicate the likelihood that the prospect will be converted into a customer. Any existing scoring on the prospect from lead scoring systems may be included or ignored. Results from previous interactions for a single prospect by a single sales agent can be scored and used to prioritize the next set of interactions to be performed for that prospect as dictated by a workflow assigned to the prospect. In some implementations, there may be a workflow engine configured to automatically schedule the next set of interactions for each prospect as each prospect moves through a workflow.

In some implementations, the outcomes of previous interactions from a range of prospects across a single sales agent can be scored. These scores can then be used to prioritize the next set of interactions for each of the analyzed prospects for that particular sales agent according to the workflow associated with each prospect. In some implementations, the outcomes of previous interactions from a range of prospects across a range of sales agents can be scored. These scores can then be used to prioritize the next set of interactions for each of the analyzed prospects for each of the analyzed sales agents according to the workflow associated with each prospect. In some implementations, the outcomes of previous interactions, grouped by any combination of prospects and agents, can be analyzed and scored. These scores can then be intersected with the defined workflow steps for each analyzed prospect to generate new interactions that were not previously part of the workflow, or to reorder the interactions of the workflow. The details of various embodiments of the present solution are set forth in the accompanying drawings and the description below.

### BRIEF DESCRIPTION OF THE FIGURES

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client device in communication with server device;

FIG. 1B is a block diagram depicting a cloud computing environment comprising client device in communication with cloud service providers;

FIGS. 1C and 1D are block diagrams depicting embodiments of computing devices useful in connection with the methods and systems described herein;

FIG. 2 is a block diagram of an example system for prioritizing prospect interactions;

FIG. 3 is a block diagram of an example interaction prioritization engine included in the system of FIG. 2;

FIG. 4 is a flowchart of an example method for generating a user interaction queue;

FIG. 5 is a flowchart of an example method for analyzing one or more interactions;

FIG. 6 is a flowchart of an example method for generating a score for a prospect;

FIG. 7 is a flowchart of an example method for delivering a list of suggested interactions;

FIG. 8 is a flowchart of an example method for updating a user interaction queue; and

FIG. 9 is a flowchart of an example method for improving electronic communications between agents and clients.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:

Section A describes a network environment and computing environment which may be useful for practicing embodiments described herein.

Section B describes embodiments of systems and methods for establishing communication channels to monitor electronic communication events in order to prioritize and improve the performance of future electronic communication events.

A. Computing and Network Environment

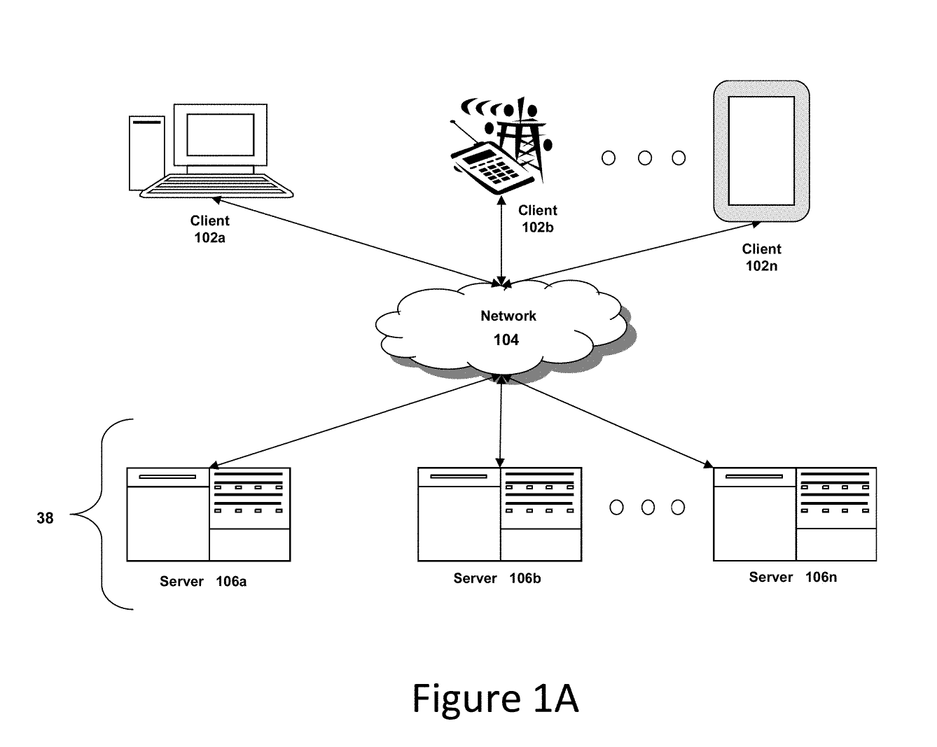

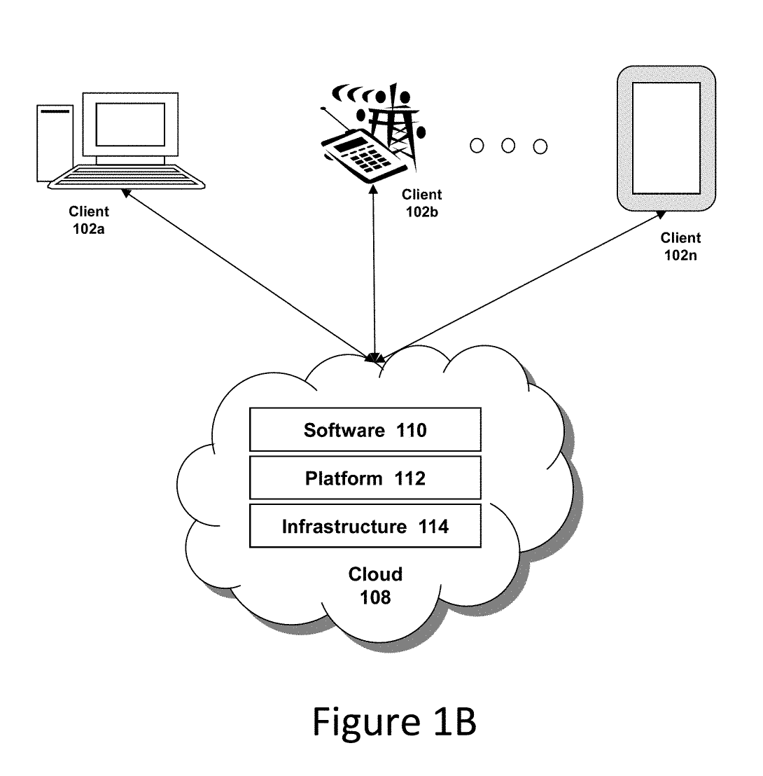

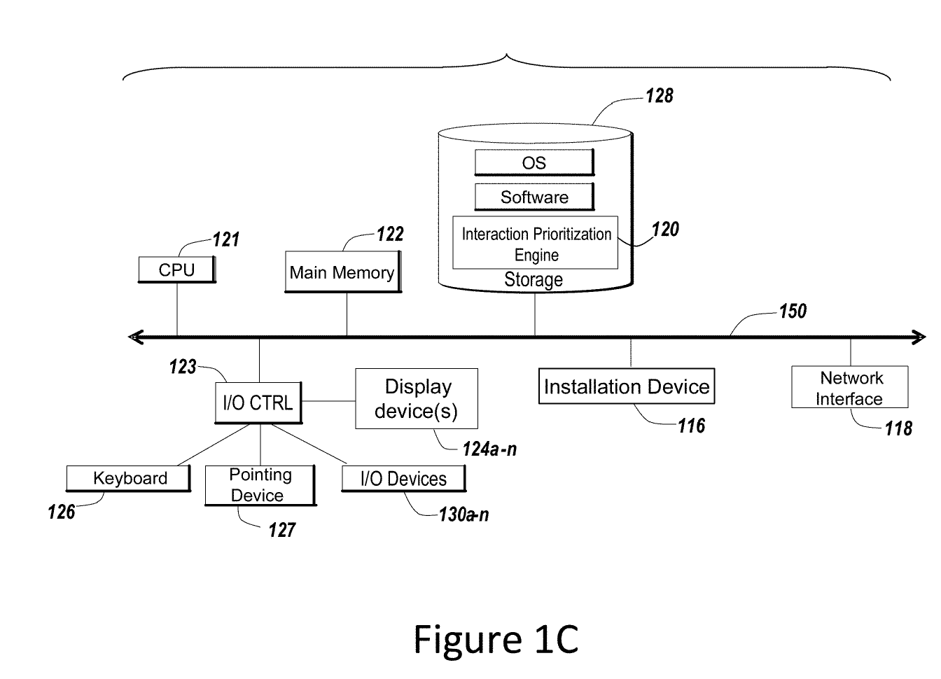

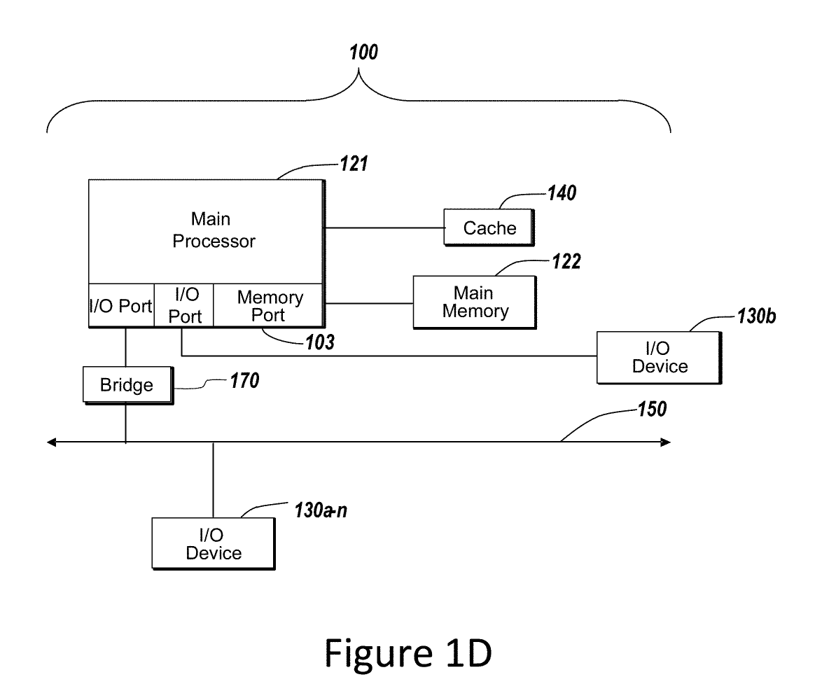

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network 104 may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 104 may be a type of a broadcast network, a telecommunications network, a data communication network, or a computer network.

In some embodiments, the system may include multiple, logically-grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS NT, manufactured by Microsoft Corp. of Redmond, Wash.), while one or more of the other servers 106 can operate on according to another type of operating system platform (e.g., Unix, Linux, or Mac OS X).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, Calif.; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, the server 106 may be referred to as a remote machine or a node. In another embodiment, a plurality of nodes 290 may be in the path between any two communicating servers.

Referring to FIG. 1B, a cloud computing environment is depicted. A cloud computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or a zero client may depend on the connection to the cloud 108 or server 106 to provide functionality. A zero client may depend on the cloud 108 or other networks 104 or servers 106 to retrieve operating system data for the client device. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud based delivery, e.g. Software as a Service (SaaS) 110, Platform as a Service (PaaS) 112, and Infrastructure as a Service (IaaS) 114. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS can include infrastructure and services (e.g., EG-32) provided by OVH HOSTING of Montreal, Quebec, Canada, AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 102 may also access SaaS resources through smartphone or tablet applications, including, e.g., Salesforce Sales Cloud, or Google Drive app. Clients 102 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g. a computer, network device or appliance capable of communicating on any type and form of network and performing the operations described herein. FIGS. 1C and 1D depict block diagrams of a computing device 100 useful for practicing an embodiment of the client 102 or a server 106. As shown in FIGS. 1C and 1D, each computing device 100 includes a central processing unit 121, and a main memory unit 122. As shown in FIG. 1C, a computing device 100 may include a storage device 128, an installation device 116, a network interface 118, an I/O controller 123, display devices 124a-124n, a keyboard 126 and a pointing device 127, e.g. a mouse. The storage device 128 may include, without limitation, an operating system, software, and an interaction prioritization engine (IPE) 120. As shown in FIG. 1D, each computing device 100 may also include additional optional elements, e.g. a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of multi-core processors include the AMD PHENOM IIX2, INTEL CORE i5 and INTEL CORE i7.

Main memory unit 122 may include one or more memory chips capable of storing data and allowing any storage location to be directly accessed by the microprocessor 121. Main memory unit 122 may be volatile and faster than storage 128 memory. Main memory units 122 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the processor 121 may use an Advanced Graphics Port (AGP) to communicate with the display 124 or the I/O controller 123 for the display 124. FIG. 1D depicts an embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple IPHONE. Some devices 130a-130n allow gesture recognition inputs through combining some of the inputs and outputs. Some devices 130a-130n provides for facial recognition which may be utilized as an input for different purposes including authentication and other commands. Some devices 130a-130n provides for voice recognition and inputs, including, e.g., Microsoft KINECT, SIRI for IPHONE by Apple, Google Now or Google Voice Search.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augment reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, an I/O device 130 may be a bridge between the system bus 150 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g. one or more hard disk drives or redundant arrays of independent disks) for storing an operating system or other related software, and for storing application software programs such as any program related to the software 120 for the interaction prioritization engine. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 128 may be non-volatile, mutable, or read-only. Some storage device 128 may be internal and connect to the computing device 100 via a bus 150. Some storage device 128 may be external and connect to the computing device 100 via a I/O device 130 that provides an external bus. Some storage device 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage device 128 may also be used as an installation device 116, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1B and 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2022, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Wash.; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google, of Mountain View, Calif., among others. Some operating systems, including, e.g., the CHROME OS by Google, may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, or a NINTENDO WII U device manufactured by Nintendo Co., Ltd., of Kyoto, Japan, an XBOX 360 device manufactured by the Microsoft Corporation of Redmond, Wash.

In some embodiments, the computing device 100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com, Inc. of Seattle, Wash. In other embodiments, the computing device 100 is an eBook reader, e.g. the KINDLE family of devices by Amazon.com, or NOOK family of devices by Barnes & Noble, Inc. of New York City, N.Y.

In some embodiments, the communications device 102 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc.; or a Motorola DROID family of smartphones. In yet another embodiment, the communications device 102 is a laptop or desktop computer equipped with a web browser and a microphone and speaker system, e.g. a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 are monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

B. Monitoring Electronic Communication Events

Aspects and implementations of the present disclosure are generally directed to systems and methods for establishing communication interfaces to monitor online interactions via event listeners. Through these communication interfaces, a system for prioritizing prospect interactions can identify online interactions and execute instructions to initiate further interactions with client devices of users preforming the identified online interactions. In some implementations, the system for prioritizing prospect interactions can include an interaction prioritization engine that includes one or more processors and can be configured to deploy one or more event listeners to monitor for interactions between an entity and visitors or potential clients of the entity. The event listeners can be configured to receive interaction related data via one or more communication channels monitored by the event listeners. The interaction prioritization engine can be configured to analyze the interaction related data to determine actions the interaction prioritization engine can perform to move the visitors along the sales process. The actions can be automated interactions with one or more accounts of the visitors or may correspond to generating notifications, alerts or other triggers to provide to sales agents of the entity to move the visitors along the sales process.

The present disclosure relates to addressing some of the deficiencies of automated marketing platforms. Sales agents are often better-suited than automated marketing systems (e.g., call centers) for interacting with prospects in a way that leads to conversion, because sales agents can communicate with a prospect more personally. For example, sales agents can interact with a prospect across a range of channels that can include social media, text, email, and telephone calls. The effectiveness of these mechanisms of outreach by a sales agent can be contingent upon researching the prospect and following a predefined process of interaction. For instance, many organizations use processes that define a mix of outreach such as calling the prospect on day one, social media outreach on day two, emailing the prospect on day three, and calling again on day four. These processes can vary substantially from organization to organization, but typically are most effective when they include personal outreach by a sales agent. There are often multiple processes into which prospects can be placed, with the process selected being targeted to demographic and firmographic details of the prospect.

The outcome of one step of the sales process for outreach can directly impact sequential steps in the process. For instance, a phone call on day one might indicate that the prospect is unavailable for the next three days. This could indicate to a sales agent that the agent should focus on other prospects in the meantime. In another example, a prospect may respond to an email, indicating that a phone call that same day would be the best choice of interaction for a sales agent to take to progress the cycle with respect to that prospect.

While sales agent outreach is often more effective, it also can be much more costly. The cost to employ sales agents and the amount of time it takes for each sales agent to research each prospect can be substantial. As each sales agent is often dealing with a large volume of prospects, understanding which activity to perform next based on previous interactions is often lost. This can result in wasted time and delays in advancement of the sales cycle.

To increase the efficiency of the sales cycle and reduce costs, interactions of the sales cycle can be optimized and prioritized. Various interactions that may be included in the sales process can be scored and prioritized based on their likelihood of gaining a response from a prospect. Additionally, analysis of the success and failure of different interactions can be used to suggest mechanisms of outreach that might not be included within the current sales process, but which are likely to gain a direct response from the prospect.

In some implementations, a numerical score may be assigned to the prospect to indicate the likelihood that the prospect will be converted into a customer. Any existing scoring on the prospect from lead scoring systems may be included or ignored. Results from previous interactions for a single prospect by a single sales agent can be scored and used to prioritize the next set of interactions to be performed for that prospect as dictated by a workflow assigned to the prospect. In some implementations, there may be a workflow engine configured to automatically schedule the next set of interactions for each prospect as each prospect moves through a workflow.

In some implementations, the outcomes of previous interactions from a range of prospects across a single sales agent can be scored. These scores can then be used to prioritize the next set of interactions for each of the analyzed prospects for that particular sales agent according to the workflow associated with each prospect. In some implementations, the outcomes of previous interactions from a range of prospects across a range of sales agents can be scored. These scores can then be used to prioritize the next set of interactions for each of the analyzed prospects for each of the analyzed sales agents according to the workflow associated with each prospect. In some implementations, the outcomes of previous interactions, grouped by any combination of prospects and agents, can be analyzed and scored. These scores can then be intersected with the defined workflow steps for each analyzed prospect to generate new interactions that were not previously part of the workflow, or to reorder the interactions of the workflow.

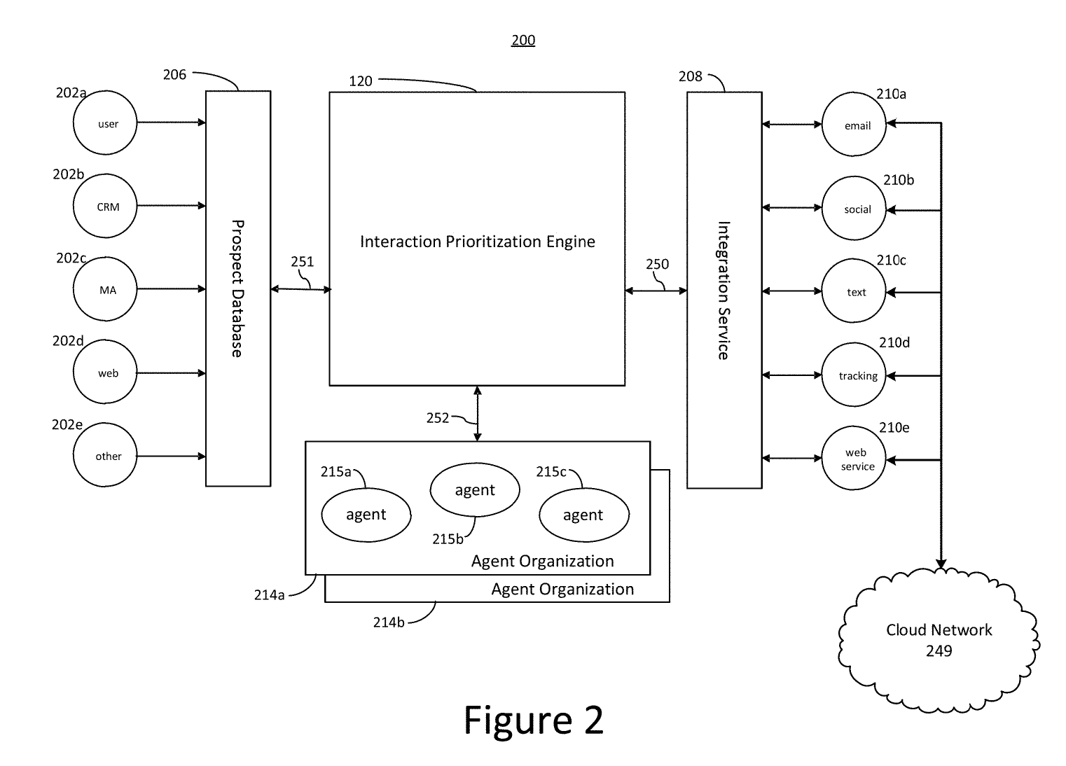

FIG. 2 is a block diagram of an example system 200 for prioritizing prospect interactions. The system 200 includes a plurality of prospect sources 202a-202e, a prospect database 206, and an interaction prioritization engine 120. The prospect database 206 is communicatively coupled to the interaction prioritization engine 120 by an interface 251. The system 200 also includes a plurality of agent organizations 214a and 214b, which each include a respective plurality of agents 215a-215c. It should be noted that, in some implementations, the system 200 can include more or fewer agent organizations similar to the agent organizations 214, and that each agent organization 214 can include any number of agents 215. The interaction prioritization engine 120 is communicatively coupled to the agent organizations by an interface 252. The system 200 also includes a plurality of listeners 210a-210e, each of which is coupled to a cloud network 249 and to an integration service 208. The interaction prioritization engine 120 is communicatively coupled to the integration service 208 by an interface 250.

The system 200 can be used to identify or recommend prospects to each of the agents 215 of the various agent organizations 214, as well as to identify or recommend a set of interactions that the agents 215 should make with their respective prospects to improve the likelihood of converting a prospect into a customer. In some implementations, the agent organizations 214 may be businesses, non-profit entities, government organizations, or any other type of group that employs or is otherwise associated with one or more people who hope to gain clients for the organization. In some implementations, the agent organizations 214 can be sales agent organizations employing personnel who sell goods or services to others. The agents 215 may execute on computing devices assigned to or otherwise associated with employees of the agent organizations 214, or other personnel who may have some other type of affiliation with their respective agent organization 214. For example, an agent organization 214 may be a real estate business employing personnel who seek buyers for various properties. In this example, prospects may be any person or other entity who is potentially interested in purchasing property from an employee associated with one of the agents 215. It should be noted that, while this disclosure refers primarily to sales agent organizations, in some implementations the agent organizations 214 may be involved in activities other than the sale of goods or services. For example, in some implementations, the agents 215 may be computing devices assigned to executive recruiters looking to fill open positions at various companies, and the prospects may represent potential employees who could be recruited to fill the open positions. In general, agents 215 may represent computing devices assigned to any person who seeks to form a relationship with a prospect.

The system 200 can identify prospects based on the various prospect sources 202, and can store information relating to the prospects in the prospect database 206. For example, the source 202a can represent a user of the system 200 who may self-identify as a prospect, based on a need or desire to purchase goods from a personnel associated with an agent 215. The sources 202 also may include the CRM source 202b or the MA source 202c. The sources 202 also include web-based sources 202d. In some implementations, the web-based sources 202d may include an automated web scraper configured to search a computer network, such as the Internet, for information related to prospects that may be of interest. For example, the web-based source 202d may search the websites of companies whose businesses are related to the products or services sold by a personnel associated with one or more of the agents 215, and may identify prospects by identifying information about the employees who work for such companies. All of the sources 202 may transmit prospect information to the prospect database, where the information may be stored. In some implementations, prospect information can include information identifying a prospect by name or business, contact information for a prospect, information about an employer that a prospect is affiliated with, and information about the likelihood of a prospect being converted to a customer by the personnel associated with a given agent 215.

The listeners 210 can be configured to detect or receive information from the cloud network 249 that may be relevant to prospects stored in the prospect database 206. In some implementations, the cloud network 249 may be or may include a large computer network, such as the Internet. In some implementations, the cloud network 249 also may be or may include cellular communication towers in a wireless network. In still other implementations, the cloud network 249 may be a network that hosts services provided by one or more agent organizations 214, such as an enterprise network maintained by any of the agent organizations 214. The listeners 210 can collect various information from the cloud network 249 to generate additional knowledge about prospects and about interactions that have occurred between personnel associated with a particular one of the agents 215 and prospects. For example, the email listener 210a may be configured to examine emails received at an email account associated with one or more of the agents 215. The email listener 210a can collect such information, for example, from an email server included in the cloud network 249. In some implementations, the email listener 249 can analyze emails to determine whether the emails have been sent to or from one of the prospects included in the prospect database 206. Such emails may indicate that the personnel associated with the agent 215 has had an email interaction with a prospect. In some implementations, the listener 210a can be further configured to extract contextual information from emails that have been sent to or from a prospect. For example, the listener 210a can be configured to determine whether such an email indicates that an interaction was relatively meaningful (e.g., by determining that the email is long) or less meaningful (e.g., by determining that the email is short). In some implementations, determining whether an email is long or short may include determining, by the interaction prioritization engine 120, a number of characters or a number of words included in the email. The interaction prioritization engine 120 can then compare the number of characters or the number of words included in the email to a threshold value selected to separate long emails from short emails. If the number of characters or the number of words included in the email exceeds the threshold, the interaction prioritization engine 120 can determine that the email is long. However, if the number of characters or the number of words included in the email falls below the threshold, the interaction prioritization engine 120 can determine that the email is short.

In some implementations, the interaction prioritization engine 120 also may determine whether the interaction was a positive interaction for the prospect or a negative interaction. In some implementations, the interaction prioritization engine 120 can determine whether an email interaction was positive or negative by analyzing the words, phrases, or sentences included in the email. For example, the interaction prioritization engine 120 can maintain a list of words, phrases, or sentences that are associated with positive email interactions, and another list of words, phrases, or sentences that are associated with negative email interactions. Such a lists can be stored, for example, in a database or other storage device. The interaction prioritization engine 120 can parse an email to extract the words, phrases, and sentences included in the email, and can compare the extracted words, phrases, or sentences to those included in the lists associated with positive and negative email interactions. In some implementations, the interaction prioritization engine 120 may determine that the email is positive if the number of words, phrases, and sentences included in the email that match those associated with positive interactions exceeds the number of words, phrases, and sentences included in the email that match those associated with negative interactions. Conversely, the interaction prioritization engine 120 may determine that the email is negative if the number of words, phrases, and sentences included in the email that match those associated with negative interactions exceeds the number of words, phrases, and sentences included in the email that match those associated with positive interactions.

The other listeners 210 may be similarly configured to collect or receive information and to extract contextual information from their respective sources. In some implementations, the social listener 210b may be configured to scan social media content (e.g., on the Internet) for posts or other information that may indicate an interaction between the personnel associated with an agent 215 and a prospect. For example, the social media listener 210b may receive information from a social media account owned by the personnel associated with an agent 215 and accessed using that agent 215, such as a Twitter or Facebook account, and may process the information to determine when the personal uses the agent 215 to send or receive information to or from a social media account associated with a prospect. Like the email listener 210a, the social media listener 210b also can be configured to extract contextual information from information it receives, and to process the contextual information to determine additional information about each identified social media interaction, such as whether each social media interaction was positive or negative.

The text listener 210c can be configured to collect or receive information relating to text messages sent to or from a phone number associated with personnel assigned to an agent 215. In some implementations, the agent 215 may be a computing device, or a software program executing on a computing device, that is used to send or receive text messages to a prospect. For example, the agent 215 may be a personal computer or other wireless communication device, or may be executing on such a computer or wireless communication device. In some implementations, the text listener 210c can determine when a text message has been sent or received from a prospect, and can extract relevant contextual information from such a text message in a manner similar to that discussed above in connection with the email listener 210a and the social listener 210b. Similarly, the tracking listener 210d can be configured to track information corresponding to various online activity of prospects that may be relevant to the sales cycle.

The web service listener 210e can be configured to process any information available on the Internet to determine whether an interaction has taken place between the personnel associated with an agent 215 and a prospect. For example, the web server may be configured to periodically or continuously monitor information on selected websites, such as forums or business websites related to the products or services that the personnel sells. Such information can be collected and processed by the web service listener 210e to determine whether the information corresponds to an interaction between a prospect and the personnel. If it does, then the web service listener 210e can be configured to extract contextual information. All of the information collected, received, or extracted by any of the listeners 210 may be transmitted to the integration service 208, which may aggregate the information and send it to the interaction prioritization engine 120 via the interface 250. This information, together with the information included in the prospect database and any other information that may be received directly from the agents 215 or agent organizations 214, may be used by the interaction prioritization engine 120 to provide an ordered list of interactions that personnel associated with each agent 215 should perform in order to improve the probability of converting a prospect into a customer.

In some aspects, the listeners 210 comprise an innovative, non-conventional and/or non-routine implementation. In some aspects, the listeners 210 are implemented to address the technical problems and challenges of prior systems not deploying the present solution. In some aspects, the listeners 210 are implemented to make or cause more effective and efficient use of computing and networking resources. For example, the listeners 210 can cause more effective and efficient use of computing and network resources by reducing the number of processing cycles, memory, or network bandwidth used to examine various types of electronic communication events and to determine actions associated with such events. The listeners 210 can provide an improved determination of actions associated with electronic communication events by integrating or interfacing with the integration service 208 to aggregate the information collected or determined by the listeners 210.

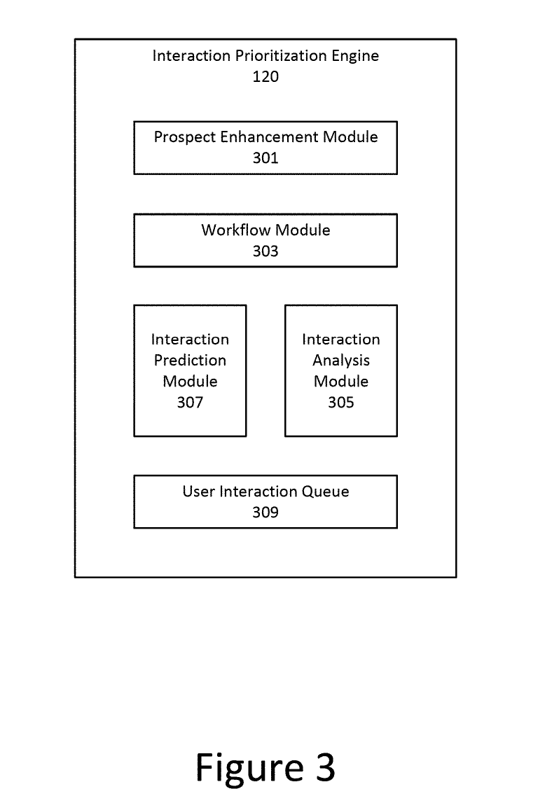

FIG. 3 is a block diagram of the interaction prioritization engine 120 included in the system 200 of FIG. 2. The interaction prioritization engine 120 includes a prospect enhancement module 301, a workflow module 303, an interaction prediction module 305, an interaction analysis module 307, and a user interaction queue 309. Together, the components of the interaction prioritization engine 120 can be used to generate a list of interactions to be performed by personnel associated with an agent, such as the agents 215 shown in FIG. 2.

The prospect enhancement module 301 can be configured to enhance the known information about a particular prospect. For example, in some implementations, the prospect enhancement module 301 can be configured to receive information from the various other components of the system 200 shown in FIG. 2, such as the prospect database 206, the agent organizations 214, and the integration service 208. For each prospect in the prospect database, the prospect enhancement module 301 can aggregate all of the information received from other sources. In some implementations, the prospect enhancement module 301 can be configured to store the aggregated information in one or more data structures associated with the prospect, so that the enhanced prospect information can be passed to other modules within the interaction prioritization engine 120.

In some aspects, the prospect enhancement module 301 comprises an innovative, non-conventional and/or non-routine implementation. In some aspects, the prospect enhancement module 301 is implemented to address the technical problems and challenges of prior systems not deploying the present solution. In some aspects, the prospect enhancement module 301 is implemented to make or cause more effective and efficient use of computing and networking resources. For example, the prospect enhancement module 301 can cause more effective and efficient use of computing and network resources by reducing the number of processing cycles, memory, or network bandwidth used to enhance known information about a particular prospect. The prospect enhancement module 301 can enhance prospect information by integrating or interfacing with the integration service 208, which receives information from the listeners 210, as shown in FIG. 2.

The workflow module 303 can be configured to generate workflows for each of the personnel associated with the agents 215. In some implementations, each agent can be assigned or otherwise associated with a single respective workflow. A workflow may be a set of tasks for the personnel associated with the agent to perform in order to convert prospects into customers. In some implementations, the tasks of a workflow may be arranged in an order that is selected to improve the efficiency with which the tasks can be carried out and to improve the likelihood that performing the tasks in the workflow will result in a relatively high number of prospect conversions.

In some implementations, the workflow module 303 can generate graphical data corresponding to each generated workflow. The graphical data can include any information necessary to electronically display information relating to a workflow. For example, the graphical information can include layout data for arranging the workflow information within a window of a graphical user interface (GUI) that may be displayed on one of the agents 215 shown in FIG. 2. In some implementations, the workflow module 303 also can generate other information relating to such a GUI. For example, the workflow module 303 can generate information corresponding to user-selectable buttons to be displayed along with workflow information in a GUI. Thus, personnel associated with an agent may interact with the GUI provided by the workflow module 303 to input various forms of information, such as indications of when tasks displayed in a workflow have been completed.

In some implementations, the workflow module 303 also may generate data corresponding to buttons, icons, or other actionable objects that personnel may interact with to initiate interactions with prospects. For example, the GUI provided by the workflow module 303 may include actionable objects to initiate a telephone call, send an email, send a text, or post content on social media. These actionable objects can be included in the GUI window that is displayed on an agent, and the personnel associated with that agent can use the actionable objects to easily initiate interactions with the prospects. In some implementations, the workflow module 303 also can receive an indication of the actionable objects that have been selected by the personnel and can update the workflow data accordingly. For example, the workflow module 303 may receive an indication that the personnel has completed an interaction associated with a workflow, and may update the workflow to remove the completed interaction. In some implementations, the workflow module 303 may alter the GUI data it provides to the agent associated with the personnel to reflect any of the changes that have been made to the workflow.

The interaction analysis module 305 can be configured to analyze interactions to determine whether the interactions were positive or negative, and to extract other contextual information about the interactions. For example, the interaction analysis module 305 can collect or receive interaction information from the integration service 208 shown in FIG. 2, which in turn receives information from the listeners 210. Based on the received information, the interaction analysis module 305 can determine which types of interactions a particular prospect responds well to, which types of interactions the prospect responds poorly to, and which types of interactions have not yet been made with a particular prospect. The interaction analysis module 305 also can be configured to determine whether a particular prospect responds more favorably to interactions with personnel associated with a particular agent 215 than to interactions with personnel associated with a different agent 215. In some implementations, the interaction analysis module 305 can be configured to generate a numerical score for each interaction. The numerical score for an interaction can indicate how useful the interaction was in advancing a prospect through the conversion cycle. In some implementations, a higher score can indicate a more positive interaction.

All of the information received and extracted by the interaction analysis module 305 can be used by the interaction prediction module 305 to determine the likely results for a given future interaction. For example, the interaction prediction module 307 can be configured to determine whether a prospect is likely to respond well to a certain interaction in the future. The interaction prediction module 307 can generate this determination based on information relating to how the prospect responded to past interactions, which it can receive, for example, from the interaction analysis module 305. In some implementations, the interaction prediction module 307 can be configured to generate a numerical score for each future interactions in a manner similar to that discussed above in connection with the interaction analysis module 307. In some implementations, the interaction prediction module 307 can produce information that may be used by the workflow module 303 to adjust a workflow associated with a particular agent. For example, if the interaction prediction module 307 determines that a particular future interaction is likely to be relatively beneficial in the cycle of converting a prospect into a customer, that interaction may be given a higher priority than other interactions in the workflow for that agent. The interactions in the workflows for the various agents can then be added to the user interaction queue 309.

In some aspects, the interaction prediction module 307 comprises an innovative, non-conventional and/or non-routine implementation. In some aspects, the interaction prediction module 307 is implemented to address the technical problems and challenges of prior systems not deploying the present solution. In some aspects, the interaction prediction module 307 is implemented to make or cause more effective and efficient use of computing and networking resources. The interaction prediction module 307 can cause more effective and efficient use of computing and network resources by reducing the number of processing cycles, memory, or network bandwidth used to determine the likely results of a future interaction. For example, the interaction prediction module 307 can integrate or interface with the interaction analysis module 305. Together, the interaction prediction module 307 and the interaction analysis module 305 can receive information corresponding to electronic communication events, extract contextual information from the electronic communication events, process the extracted information to analyze the electronic communication events to determine whether such electronic communication events were positive or negative, and can use the analysis to predict the likelihood that future communication events will be positive or negative.

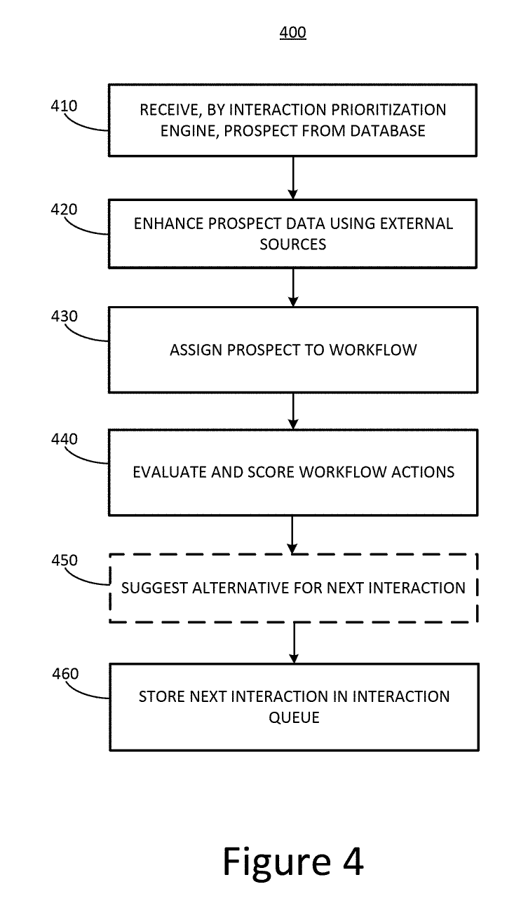

In some implementations, the user interaction queue can be any form of data storage element that is capable of storing information relating to user interactions. For example, the user interaction queue may be a data structure stored in a database that includes such information. The data structure may include elements arranged in a queue-like fashion such that elements in the queue are arranged according to indices indicating a priority for the respective elements. In some implementations, the data structure may include additional fields capable of associating additional information with each element in the data structure. For example, each element may have fields to store information corresponding to an overall score the interaction, a communication channel for the interaction, a source and destination for the interaction (e.g., to: and from: fields for an email message transaction), and information corresponding to the content of the interaction (e.g., text to be included within the body of an email message). In some implementations, the data structure may further include additional fields for each element, such as pointers to other interactions having a matching source or destination field. In some implementations, the user interaction queue may be a data structure maintained on a physical storage device, such as a hard disk drive. The user interaction queue can store information relating to the various interactions to be performed by personnel associated with a particular agent, as well as the order in which the interactions should be performed. Thus, in one example, the user interaction queue may be implemented as an array data structure in which each element in the array corresponds to a particular interaction, and the index number of each element in the array specifies the order in which the interactions are to be performed. For example, the interaction associated with the array element having an index number of 0 may be performed before the interaction associated with the array element having an index number of 1, and so on. The functionality of the various modules shown in FIG. 3, and of the interaction prioritization engine 120 as a whole, are described more fully below in connection with FIGS. 4-9.

In some aspects, the system of the present solutions implements a combination of the listeners 210, the integration service 208, the prospect enhancement module 301, the interaction prediction module 307, and other components described above in an innovative, non-conventional and/or non-routine manner to more efficiently and effectively use computing and networking resources. For example, information identifying a prospect or client can be stored in a database. The listeners 210 can extract additional electronic information relating to the clients or prospects in an automated manner, for example by scraping social media profiles or by automatically identifying and parsing emails, electronic calendar items, electronic voice calls, text messages or other forms of electronic communication exchanged with the clients or prospects. Such information can be used by the prospect enhancement module 301 to enhance the known information about the clients or prospects. Based on the enhanced information, the interaction prediction module 307 can evaluate electronic communication events that occurred in the past and can predict the likely outcome of future electronic communication events. Thus, the systems described in this disclosure can generate electronic communication events and can store in the electronic communication events in a data structure, such as a queue, that prioritizes electronic communication events which are more likely to have a favorable outcome. The components of the system as shown in FIGS. 2 and 3 are integrated in an innovative, nonconventional manner to mitigate, reduce, prevent, or resolve the technical problems of managing and prioritizing communication events between business entities in a manner that reduces the total volume of such communication events and allows for the use of less complex and costly systems. For example, the components of the systems described above address at least these technical problems by identifying a client (e.g., a prospect), generating a client ranking score of the client by applying a predetermined weight to each of a plurality of first electronic communication events between an agent and the client, detecting an action of the client performed responsive to a second electronic communication event between the agent and the client, modifying the baseline score of the second electronic communication event based on a predetermined weighting of an action type of the action to generate an event action score, adjusting the client ranking score of the client based on the event action score, and updating a queue arranged by client ranking scores stored in memory of the server to prioritize transmission of subsequent electronic communication events between the agent and the client.

In some implementations, the interaction prioritization engine 120 is an integrated, specialized computing system that is specially programmed and coded to generate, insert, and/or identify an event communication tracker and to receive feedback responsive to the tracker to dynamically update a database responsive to receiving the feedback. The database is specially designed to be updated in real-time by the interaction prioritization engine 120 to allow the plurality of agents 215 real-time access to status updates of event communications between the plurality of agents 215 and the plurality of clients. Details regarding such a tracker are described further below.

FIG. 4 is a flowchart of an example method 400 for generating a user interaction queue. In brief overview, the method 400 includes receiving, by an interaction prioritization engine, a prospect from a prospect database (step 410), enhancing data associated with the prospect using external sources (step 420), assigning the prospect to a workflow (step 430), evaluating and scoring workflow actions (step 440), suggesting an alternative for the next interaction (step 450), and storing the next interaction in the interaction queue (step 460). In FIG. 4, and throughout this disclosure, method steps are shown in broken lines to indicate that they are optional, and may not be performed in every implementation of the method.

Referring again to FIG. 4, and in greater detail, the method 400 can include receiving, by an interaction prioritization engine, a prospect from a prospect database (step 410). In general, a prospect can include an identification of a person or organization who may be a potential customer for personnel associated with at least one agent, such as one of the agents 215 shown in FIG. 2. The interaction prioritization engine also may receive additional information about the prospect, such as contact information and information about the prospect's business needs. In some implementations, the prospect information can be “pushed” from the prospect database to the interaction prioritization engine without the need for the interaction prioritization engine to explicitly request an identification of a prospect. In some other implementations, the interaction prioritization engine can instead be configured to “pull” the prospect information from the prospect database by requesting such information periodically.

The method 400 also can include enhancing data associated with the prospect using external sources (step 420). In some implementations, this step can be carried out by a module associated with the interaction prediction engine, such as the prospect enhancement module 301 shown in FIG. 3. For example, in some implementations, the prospect enhancement module can be configured to establish a communication interface with each of a plurality of sources, such as the prospect database 206, the agent organizations 214, and the integration service 208 shown in FIG. 2. After such communication interfaces have been established, the prospect enhancement module can be configured to receive information from the sources via the established communication interfaces. In some implementations, the prospect enhancement module can be configured to transmit a request for the information provided by each of these sources. In some other implementations, the sources may be configured to transmit information to the prospect enhancement module without first receiving a request for such information. The prospect enhancement module can aggregate such information. In some implementations, the prospect enhancement module may generate one or more data structures and may store the aggregated information in the one or more data structures. In some other implementations, the prospect enhancement module may transmit the aggregated data via a communication interface to a database, where the aggregated data can be stored.

The method 400 also can include assigning the prospect to a workflow (step 430). In some implementations, a workflow can be a set of tasks to perform, such as interactions with a prospect. A workflow may be associated with respective agent assigned to particular personnel, such that each agent is associated with a single workflow. In some implementations, the prospect may be assigned to a workflow based on a likelihood that the personnel assigned to the agent associated with the workflow will be able to convert the prospect into a customer. For example, the prospect may be added to a workflow for an agent based on a commonality between the business needs of the prospect and the goods or services sold by the personnel assigned to the agent. In some implementations, a prospect may be added to more than one workflow. For example, the workflows of two or more agents may include interactions to perform with the same prospect.

The method 400 also can include evaluating and scoring workflow actions (step 440). In some implementations, workflow actions (i.e., interactions between personnel assigned to an agent and a prospect) may be evaluated by a module such as the interaction analysis module 305 shown in FIG. 3. In some implementations, the score for a prospect can be based in part on any of the data collected for that prospect. For example, any past interaction with the prospect can impact the score for a prospect. In some implementations, firmographic or demographic data can be used to adjust the score of a prospect. For example, a prospect who is employed by a firm that is likely to require the goods or services provided by personnel assigned to an agent may be assigned a relatively higher score than a prospect who is employed by a firm that is unlikely to require the goods or services provided by the personnel assigned to the agent. Similarly, a prospect who is located in a geographic area that is close to the location of personnel assigned to an agent may be assigned a relatively higher score than a prospect who is located in a geographic area that is far from that personnel, as many prospects would prefer to do business with personnel in their area.

In some implementations, the score for a given prospect may be reduced if that prospect has not recently had an interaction with personnel assigned to an agent. For example, a lack of recent interaction between personnel and a prospect may indicate that the prospect has a low level of interest in doing business with the personnel. For example, the interaction analysis module may determine the times at which each interaction associated with a prospect took place. The interaction analysis module may make such determinations based on information associated with the interactions, such as timestamps associated with text message, email, or social media interactions. In some implementations, the interaction analysis module may compare the times for various interactions to one or more threshold times for determining recency. For example, the interaction analysis module may determine that interactions occurring within the past three days are “recent,” and may therefore increase the score for a given prospect that has had an interaction with personnel associated with an agent in the past three days. Similarly, the interaction analysis module may decrease the score of a prospect that has not had an interaction with personnel associated with an agent in the past three days. In some implementations, the score for a prospect can be based in part on the number of days that have passed since the last interaction for the prospect. For example, the interaction analysis module can be configured to decrease a numerical score for a prospect by a fixed amount for each day that passes without an interaction for that prospect. In some implementations, the interaction analysis module can be configured to decrease the numerical score by 2%, 5%, 10%, 15% or 20% for each day that passes without an interaction for that prospect. Thus, the interaction analysis module can determine a baseline score for a prospect and can determine the number of days that have passed since the most recent interaction with that prospect. The interaction analysis module can then adjust the baseline score for that prospect based on the amount of time that has passed since the most recent interaction with that prospect.

As discussed above, in some implementations, a prospect may initially be assigned a baseline numerical score (e.g., “100”), and the score may be adjusted based on various factors. In some implementations, various types of interactions can be assigned respective weights that will determine their relative impact on the score assigned to a prospect. Actions and interactions that may impact the score of a prospect can include whether the prospect opens an email from a personnel, whether the prospect clicks on a link provided by a personnel, whether the prospect replies to an email from a personnel, whether the prospect visits a particular web site, whether the prospect has a telephone conversation with a personnel, and whether the prospect attends a meeting with a personnel. In some implementations, a personnel can manually configure the weight assigned to each type of interaction. For example, a personnel may assign a higher weight to a meeting in which the prospect indicated a high level of interest in becoming customer of the personnel. In another example, a personnel may assign a lower weight to a phone call in which the prospect indicated that he was not interested in becoming a customer of the personnel. In some implementations, a meeting between a prospect and a personnel may increase the numerical score of the prospect by about 50%, a retweet by the prospect of the personnel's original tweet may increase the numerical score of the prospect by about 10%, a “like” or “favorite” by a prospect of a personnel's social media post may increase the numerical score of the prospect by about 10%, a prospect opening an email received from a personnel may increase the numerical score of the prospect by about 20%, a prospect selecting a link included in an email received from a personnel may increase the numerical score of the prospect by about 30%, a prospect replying to an email from a personnel may increase the numerical score of the prospect by about 60%, a prospect visiting a selected web page may increase the numerical score of the prospect by about 5%, and a telephone call between a prospect and a personnel may increase the numerical score of the prospect by about 10%.

Each of the actions and interactions discussed above, along with their respective weights, can be stored, for example, in a data structure that is accessible by the interaction analysis module. The interaction analysis module can adjust the baseline score of a prospect based on one or more actions or interactions associated with that prospect. For example, the interaction analysis module can determine the type of interaction that has occurred, and can perform a read operation on the data structure discussed above to determine the weight that is associated with that particular type of interaction. Thus, if the prospect is associated with an interaction that the data structure indicates should increase the score of the prospect by 10%, the interaction analysis module can adjust the score for that prospect upwards by 10%.

The method 400 also can include suggesting an alternative for the next interaction (step 450). In some implementations, this step can be performed by a module such as the interaction prediction module 307 or the interaction analysis module 305 shown in FIG. 3. In some implementations, an interaction can be evaluated in comparison to another interaction, for example on the basis of their relative numerical scores. If a potential interaction has a higher score than a currently scheduled interaction, the interaction prediction module can replace the currently scheduled interaction with the interaction having a higher score. The method 400 also includes storing the next interaction in the interaction queue (step 460). In some implementations, a module such as the workflow module 303 shown in FIG. 2 can store the next interaction a data structure associated with the user interaction queue in a position behind the last interaction that has been added to the user interaction queue.

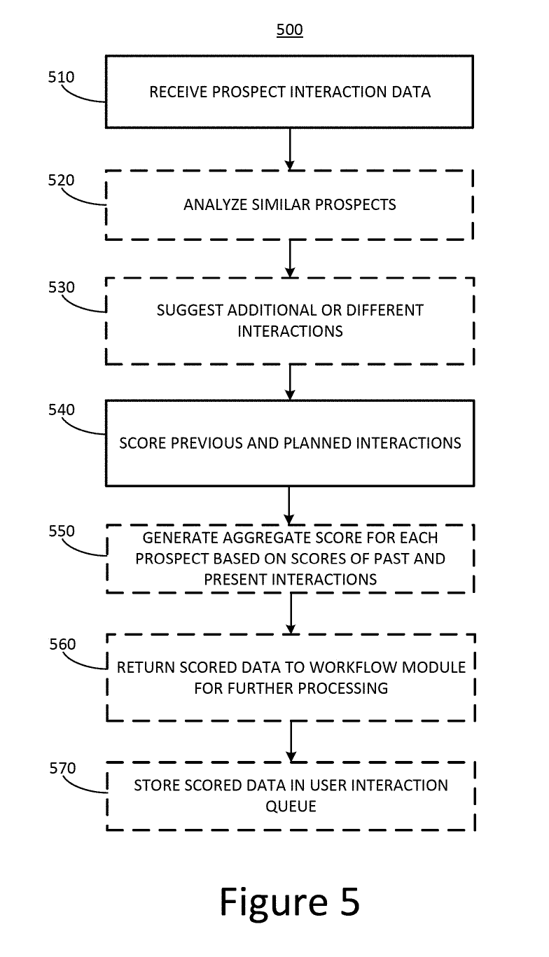

FIG. 5 is a flowchart of an example method 500 for analyzing one or more interactions. In brief overview, the method 500 can include receiving prospect interaction data (step 510), analyzing similar prospects (step 520), suggesting additional or different interactions (step 530), scoring previous and planned interactions (step 540), generating an aggregate score for each prospect based on scored of past and present interactions (step 550), returning scored data to the workflow module for further processing (step 560), and storing scored data in the user interaction queue (step 570).

Referring again to FIG. 5, and in greater detail, the method 500 can include receiving prospect interaction data (step 510). In some implementations, the prospect interaction data can be received by the interaction analysis module 305 shown in FIG. 3. As discussed above, prospect interaction data can include an identification of the prospect, and identification of the type of interaction, and additional contextual information about the interaction.

The method 500 can include analyzing similar prospects (step 520). In some implementations, this step can be carried out by the interaction analysis module 305. For example, the interaction analysis module 305 can determine a plurality of attributes for a prospect, and can select similar prospects based on those attributes. Prospect attributes may include firmographic or demographic data, as well as data relating to the types of interactions that have occurred with a prospect, such as the types of interactions to which the prospect responds most favorably. In some implementations, the interaction analysis module 305 can analyze the similar prospects by comparing their numerical scores.

The method 500 can include suggesting additional or different interactions (step 530). As discussed above in connection with FIG. 4, an interaction can be evaluated in comparison to another interaction, for example on the basis of their relative numerical scores. If a potential interaction has a higher score than a currently scheduled interaction, a module such as the interaction prediction module 307 shown in FIG. 3 can suggest, otherwise provide an indication, that the potential interaction take the place of the currently schedule interaction having the lower score.

The method 500 can include scoring previous and planned interactions (step 540). In some implementations, a module such as the interaction prediction module 307 or the interaction analysis module 305 shown in FIG. 3 can perform such scoring. In some implementations, the interaction analysis module can use firmographic or demographic data to adjust the score of an interaction. For example, an interaction with a prospect who is employed by a firm that is likely to require the goods or services provided by personnel assigned to an agent may be assigned a relatively higher score than an interaction with a prospect who is employed by a firm that is unlikely to require the goods or services provided by the personnel. Similarly, an interaction with a prospect who is located in a geographic area that is close to a personnel may be assigned a relatively higher score than an interaction with a prospect who is located in a geographic area that is far from that personnel, as many prospects would prefer to do business with personnel in their area. In some implementations, previous interactions may impact the score of future interactions with a prospect. For example, a future interaction can be impacted by whether the prospect associated with that interaction has opened an email from a personnel, clicked on a link provided by a personnel, replied to an email from a personnel, visited a particular website, or attended a meeting with a personnel. Each previous and planned interaction can be scored in a similar manner.

The method 500 also can include generating an aggregate score for each prospect based on scored of past and present interactions (step 550). In some implementations, the interaction analysis module 305 shown in FIG. 3 can generate the aggregate score. An aggregate score can be a numerical score for a prospect that indicates the likelihood that the prospect will be converted into a customer. As discussed above, an aggregate score for a prospect can be impacted by factors such as the scores for all previous interactions as well as the time at which the most recent interaction was completed. The interaction analysis module 305 can determine the interactions that have occurred with a prospect in the past, for example by retrieving such information from the prospect database 206 shown in FIG. 2 via the interface 251. The interaction analysis module 305 can then use each past interaction to adjust the score for that prospect. For example, the interaction analysis module may assign a relatively high score to a prospect with whom a personnel has had several positive interactions, and who has recently been the subject of an interaction (e.g., in the past day or in the past week). Conversely, the interaction analysis module may assign a relatively low score to a prospect with whom a personnel has had only a few positive interactions (or none), and who has not been the subject of a recent interaction. In some implementations, each interaction type may have an associated weight, and the interaction analysis module may adjust the score for a prospect based on the type and weight of the interactions associated with that prospect, as discussed above.

The method 500 can include returning scored data to the workflow module for further processing (step 560). In some implementations, the scored data can be generated by the interaction analysis module as discussed above, and the interaction analysis module can transmit the scored data to the workflow module for further processing. In some implementations, the workflow module may update a workflow for a particular sales representative based on the scored data. For example, the workflow module may rearrange certain interactions to prioritize interactions having a higher score. In some implementations, the workflow module may eliminate interactions whose score has been adjusted downward below a threshold value based on the new scored data.

The method 500 also can include storing the scored data in the user interaction queue (step 570). In some implementations, the workflow module can store the scored data in the user interaction queue. For example, the workflow module can store the score for a prospect or for a particular interaction in a data structure of the user interaction queue.

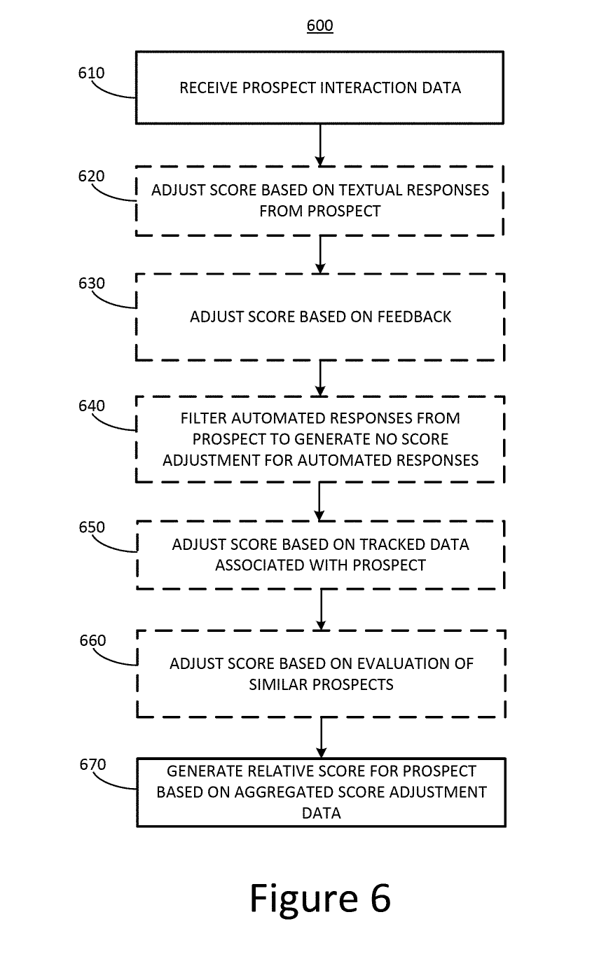

FIG. 6 is a flowchart of an example method 600 for generating a score for a prospect. In brief overview, the method 600 can include receiving prospect interaction data (step 610), adjusting the score for the prospect based on textual responses from the prospect (step 620), adjusting the score for the prospect based on feedback received from a personnel (step 630), filtering automated responses from the prospect to generate no score adjustment for automated responses (step 640), adjusting the score for the prospect based on tracked data associated with the prospect (step 650), adjusting the score for the prospect based on an evaluation of similar prospects (step 660), and generating a relative score for the prospect based on the aggregated score adjustment data (step 670).

Referring again to FIG. 6, and in greater detail, the method 600 can include receiving prospect interaction data (step 610). In some implementations, the interaction analysis module 305 shown in FIG. 3 can receive the prospect interaction data. For example, the interaction analysis module can receive prospect interaction data from the prospect database 206 shown in FIG. 2 via the interface 251. In some implementations, the interaction analysis module may transmit a request for prospect interaction data to the prospect database, and the prospect database can respond by returning the prospect interaction data. In some implementations, the interaction analysis module can receive prospect interaction data from the integration service 208 via the interface 250. In some other implementations, the interaction analysis module may receive the prospect interaction data from another of the modules shown in FIG. 3, such as the prospect enhancement module 301. As discussed above, prospect interaction data can include an identification of the prospect, and identification of the type of interaction, and additional contextual information about the interaction.

The method can include adjusting the score for the prospect based on textual responses from the prospect (step 620). In some interactions, this score adjustment can be performed by the interaction analysis module. Textual responses may include responses that the prospect has made to text messages, emails, social media posts, or any other forms of text-based communications. In some implementations, a weight may be assigned to various forms of textual response, and the interaction analysis module can adjust the score for the prospect based on the types of textual responses and their respective weights. For example, in some implementations, the interaction analysis module can maintain a lookup table associating interaction types and their respective weights. For each interaction analyzed by the interaction analysis module, the interaction analysis module can determine an interaction type of the interaction, perform a lookup in the table to determine the weight associated with that type of interaction, and adjust the score accordingly based on the weight assigned to that interaction type. In some implementations, the interaction analysis module can extract contextual information from text-based responses to more accurately adjust the score. For example, the interaction analysis module may assign a higher weight to a lengthy email response received from a prospect, as a long email may indicate a greater level of interest and therefore a higher likelihood that the prospect will be converted to a customer.

The method can include adjusting the score for the prospect based on feedback received from a sales agent (step 630). In some interactions, this score adjustment can be performed by the interaction analysis module. Personnel may use an agent such as one of the agents 215 shown in FIG. 2 to provide direct feedback on prospect to the interaction analysis module. In some implementations, the personnel may have information that is difficult to capture via the listeners 210 shown in FIG. 2, such as information that was relayed to the personnel from a prospect during a live meeting. Such interactions can still be used to adjust the score for a prospect by allowing the personnel to provide this feedback directly. In some implementations, the personnel also may assign a weight to the feedback he or she provides, depending on how strongly he or she feels about the prospect. The interaction analysis module may perform a score adjustment based on the interaction type and the custom weight for that interaction that has been provided by the personnel

The method can include filtering automated responses from the prospect to generate no score adjustment for automated responses (step 640). In some interactions, the interaction analysis module can perform the filtering. Automated responses may erroneously indicate a high level of interest on the part of a prospect. This is because automated responses occur without any action from the prospect, and therefore do not necessarily indicate that the prospect is actually interested in forming a business relationship with a personnel. As a result, including such automated responses in the score for a prospect can incorrectly indicate a high level of prospect interest when that interest does not necessarily exist. To correct this problem, the interaction analysis module can be configured to filter out automated responses to prevent them from impacting the score of a prospect. In some implementations, the interaction analysis module may determine that a response is automated by searching for particular words or phrases in the response. For example, the interaction analysis module can maintain a list of words or phrases associated with automated responses. The interaction analysis module can parse the text associated with, for example, an email interaction, and can extract the words or phrases included in the email. The interaction analysis module can then compare the words or phrases included in the email to the words or phrases that are known to be associated with automated responses. If a match is found, the interaction analysis module can filter out the interaction as automated.

The method can include adjusting the score for the prospect based on tracked data associated with the prospect (step 650). In some interactions, this score adjustment can be performed by the interaction analysis module. In some implementations, tracked data may include any other information about a prospect and his or her interactions with a sales agent, such as a number of telephone calls or meetings that have been conducted, or social media interactions in which a prospect has indicated an interest in material posted by a sales agent. Like other types of interactions, these tracked interactions also can be assigned a weight that can be selected based on the impact that each interaction should have on the prospect's score. As discussed above, the interaction analysis module can maintain a lookup table associating various forms of tracked data with respective weights. For each piece of tracked data analyzed by the interaction analysis module, the interaction analysis module can determine a type of the tracked data, perform a lookup in the table to determine the weight associated with that type of tracked data, and adjust the score accordingly based on the weight assigned to that type of tracked data.

The method can include adjusting the score for the prospect based on an evaluation of similar prospects (step 660). In some interactions, this score adjustment can be performed by the interaction analysis module. Similar prospects can be expected to respond to interactions in a similar manner, and therefore the interaction analysis module can use information that is known about one prospect to modify the score of a second prospect, provided that the first and second prospects are sufficiently similar. In some implementations, the interaction analysis module can determine similarity of prospects by identifying similarities in their respective firmographic or demographic data, or in the way the prospects respond to certain types of interactions. In one example, there may be much less data known about a new prospect, making it difficult for the interaction analysis module to generate an appropriate score for the prospect. To compensate, the interaction analysis module can adjust the score for the new prospect to be close to a score for an older prospect about whom more information is known, based on a similarity between the two prospects.

The method also can include generating a relative score for the prospect based on the aggregated score adjustment data (step 670). In some interactions, this score adjustment can be performed by the interaction analysis module. For example, as discussed above, each of the various types of interactions discussed above may be assigned a respective weight, and the interaction analysis module can use the weights of the interaction types to adjust the aggregate score of a prospect accordingly. In some implementations, a personnel can select or adjust the weights assigned to various interaction types for his or her prospects. For example, a personnel who is particularly effective at converting prospects into clients via telephone calls may assign a relatively higher weight to telephone-based interactions with prospects.

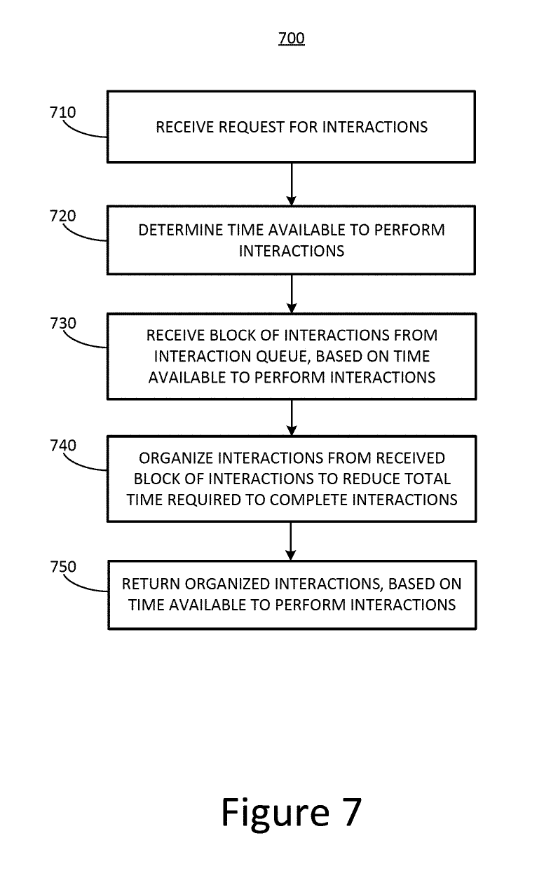

FIG. 7 is a flowchart of an example method 700 for delivering a list of suggested interactions. In brief overview, the method 700 can include receiving a request for interactions (step 710), determining a time available to perform interactions (step 720), receiving a block of interactions from the interaction queue, based on the time available to perform interactions (step 730), organizing the interactions from the received block of interactions to reduce the total time required to complete the interactions (step 740), and returning the organized interactions, based on the time available to perform the interactions (step 750).

Referring again to FIG. 7, and in greater detail, the method 700 can include receiving a request for interactions (step 710). In some implementations, a module of the interaction prioritization engine 120 shown in FIG. 2 can receive the request from one of the agents 215. For example, as discussed above, a personnel assigned to an agent may use the agent to interact with the interaction prioritization engine 120 by transmitting and receiving data via the interface 252. The personnel may request interactions in order to be given a list of interactions to perform that will increase the personnel's probability of converting prospects to customers.

The method 700 can include determining a time available for a sales agent to perform interactions (step 720). In some implementations, the workflow module 303 shown in FIG. 3 can determine the time available. In some implementations, the time available can be based on the time at which the request is received and the time at which a personnel's workday ends. For example, if the personnel makes a request for interactions at noon and typically stops working at 5:00 p.m., the workflow module can determine that the personnel has 5 hours left in the day to perform interactions. In some other implementations, the workflow module may also use other information, such as information from the personnel's calendar, to determine the amount of time available for the personnel to perform user interactions. For example, the workflow module can request access to an electronic calendar used by the personnel on one of the agents via the interface 252. The workflow module may then subtract the amount of time during which the personnel's calendar includes scheduled appointments from the amount of time left in the workday to determine the amount of time available for the personnel to perform interactions.

The method 700 can include receiving a block of interactions from the interaction queue, based on the time available for the sales agent to perform interactions (step 730). In some implementations, the workflow module can receive the block of interactions. In some implementations, each interaction included in the interaction queue may include an associated time or time range. For example, interactions that can be completed quickly, such as making a phone call, may be associated with a relatively short amount of time, while interactions that take more time to complete, such as a face-to-face meeting, may be associated with a relatively longer amount of time. In some implementations, the workflow module can select the block of interactions such that the total time required to perform all of the interactions in the block of interactions is at least as long as the time available for the user to perform interactions. Generally, the interactions included in the block of interactions can be those having the highest priority (i.e., those interactions that are at the top of the queue). Thus, in one example, the workflow module can transmit a request for the user interaction queue to return the topmost block of interactions that will occupy at least as much time as the personnel has available for the remainder of the workday.

The method 700 can include organizing the interactions from the received block of interactions to reduce the total time required to complete the interactions (step 740). In some implementations, the workflow module can perform the organization of interactions. In some implementations, arranging the interactions in a different order may alter the total amount of time required to complete the interactions. It can therefore be more efficient to arrange the interactions in an order that will help the sales agent to perform the entire block of interactions as quickly as possible. In some implementations, the interactions can be arranged such that some of the interactions may be performed simultaneously to reduce the total time required to complete all of the interactions. In some implementations, similar tasks may be arranged adjacent to one another to facilitate efficiency. For example, if the block of interactions includes several interactions that require the sales agent to send an email, these interactions can be arranged in consecutive order so that the sales agent can focus on email-based tasks without interruption. Thus, in one example, the workflow module can determine a type for each interaction in the received block of interactions. In some implementations, each interaction my include a type field that can be accessed by the workflow module. The workflow module can then rearrange the interactions such that interactions having the same type are arranged adjacent to one another.

The method 700 can include returning the organized interactions to the personnel, based on the time available for the sales agent to perform the interactions (step 750). After the interactions have been arranged in an efficient order, the workflow module can transmit data corresponding to the interactions to the agent assigned to the personnel, for example via the interface 252 shown in FIG. 2.

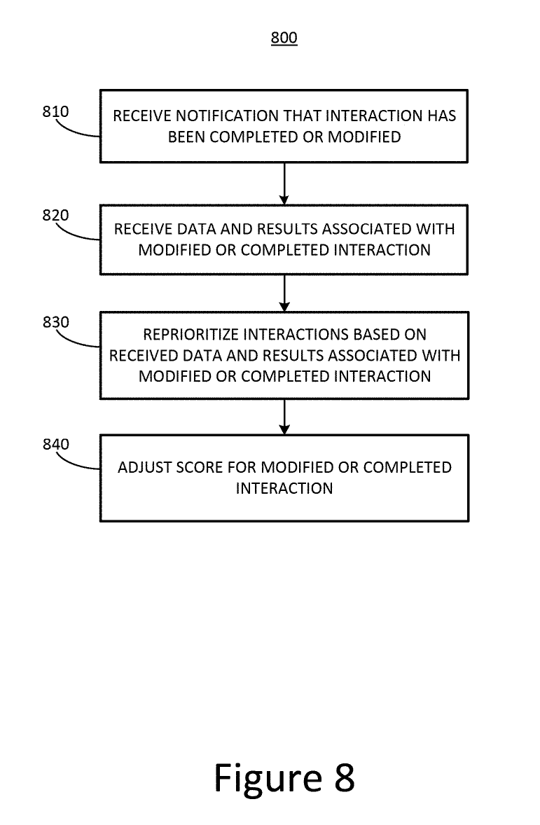

FIG. 8 is a flowchart of an example method 800 for updating a user interaction queue. In brief overview the method 800 can include receiving a notification that a personnel has completed or modified an interaction (step 810), receiving data and results associated with the modified or completed interaction (step 820), reprioritizing interactions based on received data and results associated with the modified or completed interaction (step 830), and adjusting a score for the modified or completed interaction (step 840).

Referring again to FIG. 8, and in greater detail, the method 800 can include receiving a notification that a personnel has completed or modified an interaction (step 810). In some implementations, the representative can provide the notification to the interaction prioritization engine 120 shown in FIG. 2, which can receive the notification via the interface 252. The personnel may indicate that the interaction was modified, for example, to use a different form of communication than was originally specified in the interaction. For example, an interaction may specify that a personnel should send an email to a prospect to follow up on a meeting that occurred in the past. If instead the personnel decides to follow up with the prospect via telephone rather than via email, the personnel may modify the interaction to indicate the change and may notify the interaction prioritization engine of the change. If the user simply completes an interaction in the manner that was specified originally, a notification that the interaction has been completed also can be sent to the interaction prioritization engine.

As discussed above, in some implementations the interaction prioritization engine (or one of the module associated with the interaction prioritization engine) may provide graphical data to be displayed on a GUI executed by an agent 215 as shown in FIG. 2. The GUI may allow the personnel assigned to the agent to provide input relating to completed or modified interactions. When the personnel interacts with the GUI, for example using buttons or other input elements included in the GUI, to indicate that an interaction has been completed or modified, the agent may generate a notification and transmit the notification to the interaction prioritization engine via the interface 252.

The method 800 can include receiving data and results associated with the modified or completed interaction (step 820). In some implementations, the interaction analysis module 305 shown in FIG. 3 may receive the data and results. The data and results can include any differences between the modified interaction and the original interaction. If the interaction has been completed, the results can indicate the level of success achieved by the interaction. For example, success may be indicated as a numerical value, with higher values indicating a higher level of success. In some implementations, the results may indicate that the prospect is no longer interested in becoming a customer, that the prospect has indicated an increase in interest in becoming a customer, or that the prospect has been converted to a customer. In some implementations, the results can be provided directly by the personnel who performed the interaction, for example using a GUI interface executed by an agent as discussed above. In some other implementations, the results can be extracted automatically by the interaction analysis module (or another module associated with the interaction prioritization engine), for example by processing the text of an email interaction to determine the outcome of the interaction. As discussed above, the interaction analysis module can determine the outcome of a text-based interaction such as an email by parsing the interaction to extract words, phrases, and sentences from the interaction. The interaction analysis module can maintain a list of words, phrases, and sentences that are associated with various outcomes, and can compare the extracted words to the stored words to determine one or more matches. In some implementations, the interaction analysis module can determine that the interaction is associated with a particular outcome if the interaction includes words, phrases, or sentences matching those that are associated with that particular outcome.

The method 800 can include reprioritizing interactions based on received data and results associated with the modified or completed interaction (step 830). In some implementations, the reprioritization can be performed by the workflow module 303 shown in FIG. 3. In some implementations, if the prospect has affirmatively indicated no interest in becoming a customer, the workflow module can determine that future interactions with that prospect would be ineffective, and can therefore remove any interactions associated with that prospect from the queue. Alternatively, if the results indicate that the prospect has been successfully converted to a client, then there is no need to perform any future interactions that may already be scheduled. As a result, the workflow module can remove interactions for that prospect from the queue. In some implementations, the results of an interaction may indicate that the prospect indicated a very high level of interest in becoming a customer. To increase the probability of converting such a prospect, the workflow module can move scheduled interactions with that prospect nearer to the top of the queue (or can create new interactions with that prospect and can position the new interactions near the top of the queue), so that the personnel can follow up with the prospect in a timely manner. The method 800 also can include adjusting a score for the modified or completed interaction (step 840). In some implementations, the score can be adjusted by the interaction analysis module using any of the techniques discussed above. For example, if the results indicate that the interaction was successful in converting the prospect into a customer, the interaction analysis module can increase the score associated with the interaction. On the other hand, if the results of the interaction indicate that the interaction was not successful, the interaction analysis module can decrease the score associated with the interaction.

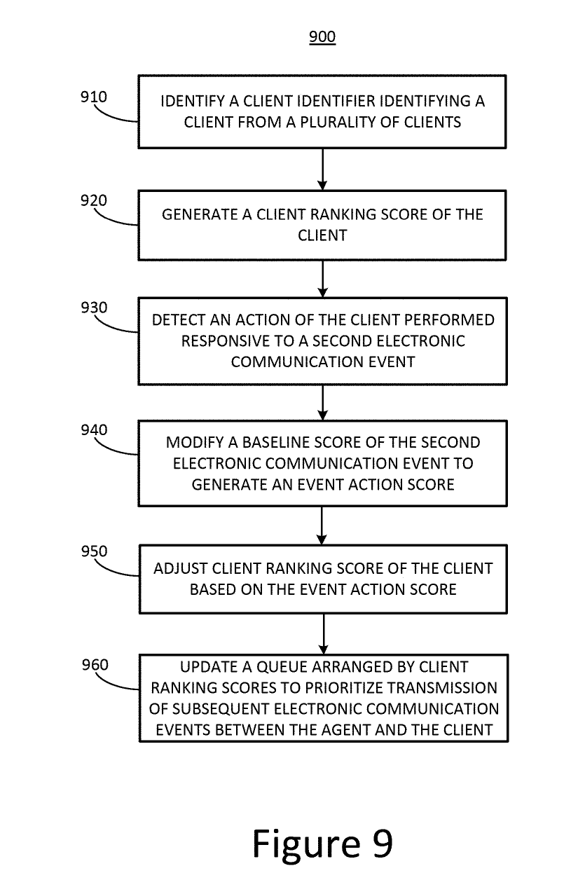

FIG. 9 is a flowchart of an example method 900 for improving electronic communications between agents and clients. In brief overview the method 900 can include identifying, by a server including one or more processors, a client identifier identifying a client from a plurality of clients (step 910). The method 900 can include generating, by the server, a client ranking score of the client by applying a predetermined weight to each of a plurality of first electronic communication events between the agent and the client based on a plurality of actions of the client performed responsive to the plurality of first electronic communication events (step 920). The method 900 can include detecting, by the server, from an electronic communication event detector executing on the server, an action of the client performed responsive to a second electronic communication event between the agent and the client, the second electronic communication event having a baseline score (step 930). The method 900 can include modifying, by the server, the baseline score of the second electronic communication event based on a predetermined weighting of an action type of the action to generate an event action score (step 940). The method 900 can include adjusting, by the server, the client ranking score of the client based on the event action score (step 950). The method 900 can include updating, based on the event action score of the client, a queue arranged by client ranking scores stored in memory of the server to prioritize transmission of subsequent electronic communication events between the agent and the client (step 960).

Referring again to FIG. 9, and in greater detail, the method 900 can include identifying, by a server including one or more processors, a client identifier identifying a client from a plurality of clients (step 910). In some implementations, the server can be a computing device such as the interaction prioritization engine 120 shown in FIG. 2, and the plurality of clients can be the clients and/or prospects stored in the prospect database 206. In some other implementations, the clients can be computing devices owned by, used by, or otherwise associated with respective prospects stored in the prospect database 206. The client identifier can be any form of information uniquely identifying the client, such as a unique string of alphanumeric characters. The server also may receive additional information about the client, such as contact information. In some implementations, the client identifier can be “pushed” from the prospect database to the server without the need for the server to explicitly request an identification of a client. In some other implementations, the server can instead be configured to “pull” the client identifier from the prospect database by requesting such information periodically.

The method 900 can include generating, by the server, a client ranking score of the client by applying a predetermined weight to each of a plurality of first electronic communication events between the agent and the client based on a plurality of actions of the client performed responsive to the plurality of first electronic communication events (step 920). In some implementations, electronic communication events may include emails, voice calls, text messages, messages exchanged via social media applications, or any other form of electronic communication occurring between the agent and the client. In some implementations, electronic communication events may be evaluated by a module of the server such as the interaction analysis module 305 shown in FIG. 3. In some implementations, the score for the client may be reduced if the client has not recently exchanged any electronic communication event with the agent.

In some implementations, a personnel can manually configure the weight assigned to each type of interaction.

Each of the plurality of first electronic communication events, along with their respective weights, can be stored, for example, in a data structure that is accessible by the server. The server can adjust the client ranking score of the client based on the plurality of electronic communication events between the client and the agent. For example, the server can determine the type of each electronic communication event, and can perform a read operation on the data structure discussed above to determine the weight that is associated with that particular type of electronic communication event. Thus, if the client is associated with an electronic communication event that the data structure indicates should increase the score of the client by 10%, the server can adjust the score for that client upwards by 10%.

The method 900 can include detecting, by the server, from an electronic communication event detector executing on the server, an action of the client performed responsive to a second electronic communication event between the agent and the client, the second electronic communication event having a baseline score (step 930). In some implementations, the electronic communication event detector can correspond to one of the listeners 210 shown in FIG. 2. For example, the electronic communication event detector may be configured to examine emails received at an email account associated with one or more of the clients. The electronic communication event detector can collect such information, for example, from an email server or other computing device communicatively coupled to the server. In some implementations, the electronic communication event detector can analyze emails to determine whether any of the emails have been sent to or from the client. In some other implementations, the electronic communication event detector may be configured to scan social media content (e.g., on the Internet) for posts or other information that may indicate an interaction between the client and the agent. In still other implementations, the electronic communication event detector can be configured to collect or receive information relating to text messages sent to or from phone numbers associated with the client and the agent.

In implementations in which the second electronic communication includes an email message, the server can be configured to insert an electronic tracker into the second electronic communication event. The tracker can help to facilitate identification of the action performed at the client. For example, the tracker can cause the client to generate one or more packets addressed to the server responsive to the action of the client. In one such example, the tracker can cause the client to send packets to the server identifying an action type, such as opening the second email, responding to the second email, clicking on a link included in the second email, or deleting the second email.

In some implementations, the second electronic communication can include an email sent by the agent to the client. Although the server is neither the sender nor the recipient of the email, the server can be configured to generate the tracker and to insert the tracker into the email. For example, in some implementations, the server can be configured to intercept the email after it is sent by the agent. The server can then insert the tracker into the email, before forwarding it on to the client. Similarly, the server can be configured to receive the packets generated by the tracker in response to an action performed by the client after receiving the email, such as the client opening or deleting the email. In some implementations, the server can notify the agent of the action that was taken by the client.

The method 900 can include modifying, by the server, the baseline score of the second electronic communication event based on a predetermined weighting of an action type of the action to generate an event action score (step 940). In some implementations, contextual information about the action also can be used to modify the baseline score of the second electronic communication event. In one example, the second electronic communication event may be an email sent to the client from the agent, and the action may be a response email sent from the client to the agent. In such an example, the server may determine whether the response email indicates that an interaction was relatively meaningful (e.g., by determining that the email is long) or less meaningful (e.g., by determining that the email is short). In some implementations, the server also may determine whether the action (i.e., the response email) was a positive or negative. For example, the server can maintain a list of words, phrases, or sentences that are associated with positive email interactions, and another list of words, phrases, or sentences that are associated with negative email interactions. The server can then parse the response email to extract the words, phrases, and sentences included in the email, and can compare the extracted words, phrases, or sentences to those included in the lists associated with positive and negative email interactions. In some other implementations, the action performed at the client may include opening the email or clicking on a link within the email. In still other implementations, the second communication event may include a voice call and the action performed at the client may include receiving the voice call, accessing a voicemail corresponding to the voice call, or disconnecting the voice call after a predetermined time duration.

In some implementations, certain actions may be primarily associated with a lower (or negative) predetermined weights. For example, actions such as ignoring an email or phone call, or sending a reply email that indicates no interest in further communication, may be actions having lower or negative predetermined weights. Conversely, positive actions such as answering a voice call or sending a positive response email, may be associated with higher weights. The server can identify the predetermined weighting of the action type, and can modify the baseline score for the second electronic communication event by applying the predetermined weighting to the baseline score.

In some implementations, the event action core can be modified based on a recency of the action. For example, the server can determine the time at which the action was performed at the client, and can subsequently determine a duration of time that has elapsed between the current time and the time at which the action was performed at the client. In some implementations, the server can adjust the event action score downwards based on a longer elapsed time (i.e., an action performed farther in the past), and can adjust the event action score upwards based on a shorter elapsed time (i.e., a more recent action). In some implementations, server can modify the event action score based on a predetermined amount per unit time of the elapsed time between the current time and the time at which the action was performed at the client.

The method 900 can include adjusting, by the server, the client ranking score of the client based on the event action score (step 950). In some implementations, the client ranking score can be adjusted in a manner similar to that in which the baseline score of the second electronic communication event itself was modified in step 940. For example, if the baseline score of the second electronic communication event was adjusted upwards in step 940 (e.g., indicating that the second electronic communication event was positive), the client ranking score of the client also can be adjusted upwards. Similarly, if the baseline score of the second electronic communication event was adjusted downwards in step 940 (e.g., indicating that the second electronic communication event was negative), the client ranking score of the client also can be adjusted downwards.

The method 900 can include updating, based on the event action score of the client, a queue arranged by client ranking scores stored in memory of the server to prioritize transmission of subsequent electronic communication events between the agent and the client (step 960). In some implementations, the adjustment of the client ranking score in step 950 may cause the ranking of the client to change relative to that of other clients. For example, if the adjustment of the client ranking score is increased as a result of the adjustment performed in step 950, the updated client ranking score may be higher than the client ranking score of one or more other clients that previously had higher client ranking scores. To account for such a change, the queue of clients can be updated such that the queue remains arranged by client ranking score even after the client ranking score for a client has been adjusted. In some implementations, the queue may be adjusted such that clients with higher client ranking scores are positioned closer to the front of the queue. In some other implementations, the queue may be adjusted such that clients with lower client ranking scores are positioned closer to the front of the queue.

In some implementations, the server can identify a set of clients based on their respective client rank scores. For example, the server may identify a set of clients positioned nearest to the front of the queue. The server also may generate a plurality of third electronic communication events to be initiated with the identified set of clients. The plurality of third electronic communication events can include, for example, emails, voice calls, text messages, or any other form electronic communication. In some implementations, the plurality of third electronic communication events may be stored in an electronic communication event queue maintained by the server.

In some implementations, the server may receive a request from the agent for a list of communication events to be initiated. In response to the request, the server may identify one or more of the third electronic communication events stored in the electronic communication event queue, and may assign the identified one or more third electronic communication events to an agent-specific communication event queue of the agent. The agent may then retrieve the one or more third electronic communication events from the communication event queue assigned to the agent.

In some aspects, the methods of the present solutions implement various combinations of steps in innovative, non-conventional and/or non-routine ways. In some aspects, the methods of the present solution combines the steps of FIGS. 4-9 in innovative, non-conventional and/or non-routine combinations to implement the improved functionality, performance and operation of the present solution. In some aspects, the methods of the present solution combine the steps of FIGS. 4-9 in innovative, non-conventional and/or non-routine manners to more efficiently and effectively use computing and networking resources. In some aspects, the methods of the present solution provide innovative, non-conventional and/or non-routine ordered combinations of steps.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are exemplary and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the exemplary embodiments and should be defined in accordance with the accompanying claims and their equivalents.

What is claimed is:

1. A method for improving electronic communications between agents and clients, comprising:
identifying, by a server including one or more processors, a client identifier identifying a client from a plurality of clients, the server communicatively coupled to an agent;
generating, by the server, a client ranking score of the client by applying a predetermined weight to each of a plurality of first electronic communication events between the agent and the client based on a plurality of actions of the client performed responsive to the plurality of first electronic communication events;
detecting, by the server, from an electronic communication event detector executing on the server, an action of the client performed responsive to a second electronic communication event between the agent and the client, the second electronic communication event having a baseline score;
modifying, by the server, the baseline score of the second electronic communication event based on a predetermined weighting of an action type of the action to generate an event action score;
adjusting, by the server, the client ranking score of the client based on the event action score; and
updating, based on the event action score of the client, a queue arranged by client ranking scores stored in memory of the server to prioritize transmission of subsequent electronic communication events between the agent and the client.

2. The method of claim 1, further comprising:
determining, by the server, a duration of time between a time at which the action was performed at the client and a current time; and
modifying the event action score based on the determined duration of time.

3. The method of claim 2, wherein modifying the event action score based on the determined duration of time further comprises modifying the event action score by a predetermined amount per unit time.

4. The method of claim 1, further comprising:
identifying the action type of the action performed at the client device responsive to the second electronic communication event; and
determining the predetermined weighting corresponding to the identified action type, wherein modifying the baseline event action score includes applying the predetermined weighting to the baseline event action score.

5. The method of claim 4, wherein the second electronic communication event is an email from the agent to the client and wherein the action type corresponds to one or more of i) opening the email; ii) clicking a link included in the email; and iii) replying to the email.

6. The method of claim 4, wherein the second electronic communication event is a voice call from the agent to the client and wherein the action type corresponds to one or more of i) receiving the voice call; ii) accessing a voicemail corresponding to the voice call; and iii) disconnecting the voice call after a predetermined time duration.

7. The method of claim 1, further comprising:
identifying, by the server, a set of clients based on client rank scores of the set of the clients;
generating, by the server, a plurality of third electronic communication events to be initiated with the identified set of clients; and
storing, by the server, the plurality of third electronic communication events in an electronic communication event queue maintained by the server.

8. The method of claim 7, further comprising:
receiving, by the server, a request from the agent to receive a list of communication events to initiate;
identifying, by the server, responsive to the request, one or more of the third electronic communication events stored in the electronic communication event queue; and
assigning, by the server, the identified one or more third electronic communication events to an agent-specific communication event queue of the agent.

9. The method of claim 1, wherein the plurality of first electronic communication events includes at least one electronic communication event corresponding to an email and at least one electronic communication event corresponding to a voice call.

10. A system for improving electronic communications between agents and clients, comprising:
a plurality of clients;
an agent; and
a server including one or more processors, the server communicatively coupled to the agent and configured to:
identify a client identifier identifying a client from the plurality of clients;
generate a client ranking score of the client by applying a predetermined weight to each of a plurality of first electronic communication events between the agent and the client based on a plurality of actions of the client performed responsive to the plurality of first electronic communication events;
detect, from an electronic communication event detector executing on the server, an action of the client performed responsive to a second electronic communication event between the agent and the client, the second electronic communication event having a baseline score;
modify the baseline score of the second electronic communication event based on a predetermined weighting of an action type of the action to generate an event action score;
adjust the client ranking score of the client based on the event action score; and
update, based on the event action score of the client, a queue arranged by client ranking scores stored in memory of the server to prioritize transmission of subsequent electronic communication events between the agent and the client.

11. The system of claim 10, wherein the server is further configured to:
determine a duration of time between a time at which the action was performed at the client and a current time; and
modify the event action score based on the determined duration of time.

12. The system of claim 11, wherein modifying the event action score based on the determined duration of time further comprises modifying the event action score by a predetermined amount per unit time.

13. The system of claim 10, wherein the server is further configured to:
identify the action type of the action performed at the client device responsive to the second electronic communication event; and
determine the predetermined weighting corresponding to the identified action type; and
modify the baseline event action score by applying the predetermined weighting to the baseline event action score.

14. The system of claim 10, wherein the server is further configured to:
identify a set of clients based on client rank scores of the set of the clients;
generate a plurality of third electronic communication events to be initiated with the identified set of clients; and
store the plurality of third electronic communication events in an electronic communication event queue maintained by the server.

15. The system of claim 14, wherein the server is further configured to:
receive a request from the agent to receive a list of communication events to initiate;
identify, responsive to the request, one or more of the third electronic communication events stored in the electronic communication event queue; and
assign the identified one or more third electronic communication events to an agent-specific communication event queue of the agent.

16. The system of claim 10, wherein the plurality of first electronic communication events includes at least one electronic communication event corresponding to an email and at least one electronic communication event corresponding to a voice call.

17. A method for improving electronic communications between agents and clients, comprising:
identifying, by a server including one or more processors, a client identifier identifying a client from a plurality of clients, the server communicatively coupled to an agent;
generating, by the server, a client ranking score of the client by applying a predetermined weight to each of a plurality of first emails between the agent and the client based on a plurality of actions of the client performed responsive to the plurality of first emails;
inserting, via the server, in a second email to the client, an electronic tracker to cause the client to generate one or more packets addressed to the server responsive to an action of the client performed responsive to the second email between the agent and the client, the one or more packets identifying an action type, the second email assigned a baseline score by the server;
detecting, by the server, from an action detector executing on the server, the action and the action type of the action;
modifying, by the server, the baseline score of the second email based on a predetermined weighting of the action type of the action to generate an email action score of the client;
adjusting, by the server, the client ranking score of the client based on the email action score of the client; and
updating, based on the email action score of the client of the client, a queue arranged by client ranking scores stored in memory of the server to prioritize transmission of subsequent electronic communications between the agent and the client.

18. The method of claim 17, further comprising:
determining, by the server, a duration of time between a time at which the action was performed at the client and a current time; and
modifying the email action score based on the determined duration of time.

19. The method of claim 18, wherein modifying the email action score based on the determined duration of time further comprises modifying the email action score by a predetermined amount per unit time.

20. The method of claim 17, further comprising:
identifying the action type of the action performed at the client device responsive to the second email; and
determining the predetermined weighting corresponding to the identified action type, wherein modifying the baseline email action score includes applying the predetermined weighting to the baseline email action score.
